(19) United States
(12) Patent Application Publication
(10) Pub. No.: US 2018/0354558 A1
(43) Pub. Date: Dec. 13, 2018

(54) FUEL CELL VEHICLE

(71) Applicant: TOYOTA JIDOSHA KABUSHIKI KAISHA, Toyota-shi (JP)

(72) Inventors: Takanori OTSURA, Toyota-shi (JP); Shigeaki MURATA, Nisshin-shi (JP); Keitaro YAMAMORI, Okazaki-shi (JP)

(21) Appl. No.: 15/962,465

(22) Filed: Apr. 25, 2018

(30) Foreign Application Priority Data
Jun. 8, 2017 (JP) 2017-113242
Sep. 21, 2017 (JP) 2017-180766

(51) Int. Cl. B62D 21/16; B62D 21/15; B62D 25/08; B62D 27/02; B60L 11/18; H01M 8/04082; B60K 13/04

(52) U.S. Cl. CPC B62D 21/16; B62D 21/155; B62D 25/08; B60K 13/04; B60L 11/1896; H01M 8/04201; B62D 27/02

(57) ABSTRACT

A fuel cell vehicle comprises a fuel cell module, a discharge port through which exhaust gas including water produced in the fuel cell module is discharged, the discharge port being disposed on an under floor and between a front wheel axle and a rear wheel axle of the fuel cell vehicle, and a guiding section capable of guiding the exhaust gas to flow toward a rearward side beyond the rear wheel axle while the fuel cell vehicle is in a non-running state.

### CROSS-REFERENCE TO RELATED APPLICATION

The present application claims priority to Japanese Patent Application No. 2017-113242 filed on Jun. 8, 2017 and Japanese Patent Application No. 2017-180766 filed on Sep. 21, 2017, the contents of which are incorporated herein by reference.

### BACKGROUND

### Field

The present disclosure relates to a fuel cell vehicle.

### Related Art

JP2015-209043A discloses a fuel cell vehicle including: a fuel cell stack on a vehicle front side, that is, in a front room for example; and a discharge port, for exhaust gas from the fuel cell stack (fuel cell module), disposed on a vehicle rearward side.

When the discharge port for the exhaust gas is disposed more on the rearward side than a rear wheel axle of the vehicle, liquid, discharged together with the exhaust gas, disperses toward the rearward side of the vehicle in a running state, and may end up on the following vehicle. When the discharge port is disposed between a front wheel axle and the rear wheel axle, the liquid is blocked by an under cover of the vehicle so as not to be dispersed toward the rearward side of the vehicle. However, in this configuration, the exhaust gas is likely to stay below the under cover when the vehicle is in a non-running state. As a result, the rear wheels might get wet by water vapor in the exhaust gas. Thus, a configuration enabling the exhaust gas to be favorably discharged also when the vehicle is in the non-running state has been called for.

### SUMMARY

According to an aspect of the present disclosure, a fuel cell vehicle is provided. The fuel cell vehicle comprises a fuel cell module, a discharge port through which exhaust gas including water produced in the fuel cell module is discharged, the discharge port being disposed on an under floor and between a front wheel axle and a rear wheel axle of the fuel cell vehicle, and a guiding section capable of guiding the exhaust gas to flow toward a rearward side beyond the rear wheel axle while the fuel cell vehicle is in a non-running state.

With this aspect, the exhaust gas including water (water vapor) can be guided by the guiding section to flow toward the rearward side beyond the rear wheel axle, while the fuel cell vehicle is in the non-running state. This ensures a lower risk of the rear wheels coming into contact with or getting wet by the water vapor. White smoke, as a result of condensation of the water vapor, does not spread from side surfaces of the fuel cell vehicle. Thus, the exhaust gas can be favorably discharged while the fuel cell vehicle is in the non-running state.

### BRIEF DESCRIPTION OF DRAWINGS

FIG. 1 and FIG. 2 are a diagrams illustrating a schematic configuration of a vehicle according to a first embodiment.

FIG. 3 is a diagram illustrating difference in a shape of a guiding section between a non-running state and a running state of the vehicle.

FIG. 4 is a diagram illustrating an example of a configuration for changing the shape of the guiding section.

FIG. 5 is a flowchart illustrating control according to the first embodiment.

FIG. 6 and FIG. 7 are diagrams illustrating how exhaust gas flows when an opening area of an outlet of the guiding section is small and not small.

FIG. 8 and FIG. 9 are diagrams illustrating another embodiment for changing the opening area of the outlet of the discharge port.

FIG. 10 and FIG. 11 are diagrams illustrating a schematic configuration of a vehicle according to a second embodiment.

FIG. 12 and FIG. 13 are diagrams illustrating a schematic configuration of a vehicle according to a third embodiment.

FIG. 14 is a diagram illustrating how the exhaust gas flows in an area X in FIG. 12, in a non-running state and in a running state.

FIG. 15 is a diagram illustrating a schematic configuration of a vehicle according to a fourth embodiment.

FIG. 16 is a cross-sectional view taken along line XVI-XVI in FIG. 15.

FIG. 17 is a diagram illustrating a schematic configuration of a vehicle according to a fifth embodiment.

FIG. 18 is a diagram illustrating a schematic configuration of the vehicle according to the fifth embodiment.

FIG. 19 is a flowchart illustrating control according to the fifth embodiment.

### DESCRIPTION OF EMBODIMENTS

In this specification, five embodiments of the present embodiments, and modifications thereof are described below. In first, second and fifth embodiments, an operation status of a guiding section is switched between a running state and a non-running state of a fuel cell vehicle 10 (abbreviated as “vehicle 10”) to change a flow velocity of exhaust gas relative to the speed of the vehicle 10. The guiding section can guide the exhaust gas to flow toward a rearward side beyond a rear wheel axle of the vehicle 10. The non-running state of the vehicle 10 is not limited to a case where the speed of the vehicle 10 is 0 km/h, and includes cases where the speed is equal to or lower than a predetermined speed Vth. The speed Vth is a predetermined value not exceeding 10 km/h for example. For example, the value is preferably lower than 7.2 km/h (2 m/s). In the first embodiment, the flow velocity of the exhaust gas is increased by setting an opening area of a discharge port through which the exhaust gas is discharged to be small while the vehicle 10 is in the non-running state. In the second embodiment, the flow velocity of the exhaust gas is increased by a fan for example, while the vehicle 10 is in the non-running state. In third and fourth embodiments, the flow velocity of the exhaust gas is not changed. Instead, a guide path (a pipe or a groove) is provided for guiding the exhaust gas toward the rearward side of the vehicle 10 while the vehicle 10 is in the non-running state. The embodiments are described in detail below.

### First Embodiment

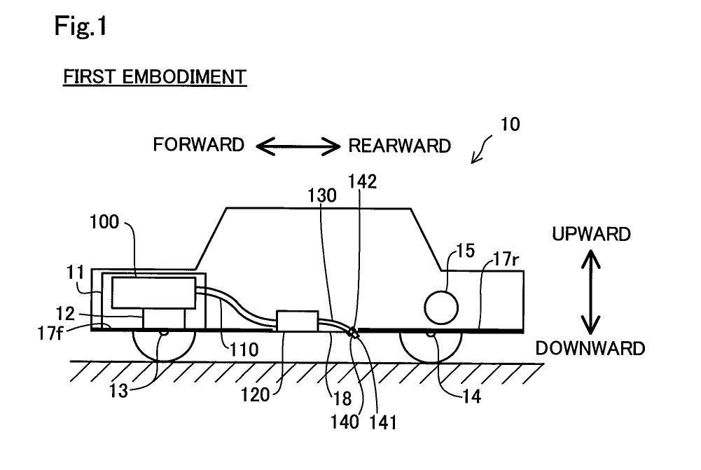

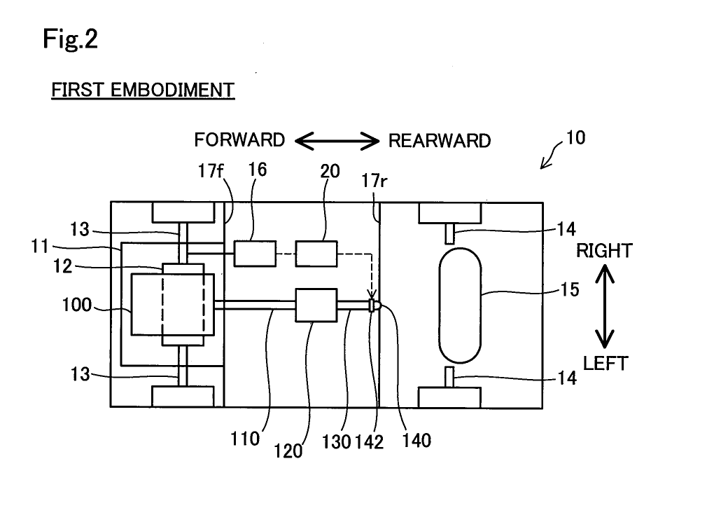

FIG. 1 and FIG. 2 are each a diagram illustrating a schematic configuration of the vehicle 10 according to the first embodiment. The vehicle 10 includes a fuel cell module 100, an exhaust gas pipe 110, a silencer 120, a discharge port 130, a guiding section 140, an actuator 142, a drive motor 12, a front wheel axle 13, a rear wheel axle 14, a fuel tank 15, a speed meter 16, under covers 17f and 17r, an under floor 18, and a controller 20.

The fuel cell module 100 is installed in a front room 11 provided in a portion on the forward side of the vehicle 10. Here, “forward” of the vehicle 10 corresponds to a traveling direction of the vehicle 10 in a normal running state, and “rearward” corresponds to a direction opposite to “forward”, “left side” and “right side” of the vehicle 10 respectively correspond to left and right relative to the traveling direction of the vehicle 10 in the normal running state, and “upward” and “downward” of the vehicle 10 respectively correspond to upper and lower sides in a vertical direction of the vehicle 10. The fuel cell module 100 has an output connected with the drive motor 12 via a DC-DC converter and an inverter (not illustrated). The drive motor 12 is connected to the front wheel axle 13. In this example, the drive motor 12 is disposed below the fuel cell module 100. Alternatively, the drive motor 12 may be disposed in the front room 11 behind the fuel cell module 100. The front wheel axle 13 is connected to the speed meter 16. The drive motor 12 may be connected to the rear wheel axle 14, or may be connected to both of the front wheel axle 13 and the rear wheel axle 14. In these cases, the speed meter 16 may be connected to the rear wheel axle 14. The fuel tank 15 for supplying fuel gas to the fuel cell module 100 is disposed substantially above the rear wheel axle 14. The under covers 17f and 17r cover the under floor 18 of the vehicle 10, and each have a substantially flat plate shape. The under covers 17f and 17r have functions of preventing trash, dust, water, or the like from entering the vehicle in the running state, and reducing resistance against air passing below the vehicle 10.

The exhaust gas pipe 110, the silencer 120, the discharge port 130, and the guiding section 140 are connected to the rearward side of the fuel cell module 100 of the vehicle 10, and are arranged in this order from the fuel cell module 100. In FIG. 1 and FIG. 2, the actuator 142 is illustrated to be disposed between the discharge port 130 and the guiding section 140. Note that the actuator 142 may be provided at any position to be capable of driving the guiding section 140. The exhaust gas pipe 110 is a pipe through which exhaust gas from the fuel cell module 100 is discharged. The exhaust gas includes air, and further includes produced water as a result of reaction in the fuel cell module 100. The produced water is discharged in a form of water vapor or liquid as a result of partial condensation of the water vapor. The water vapor cooled by being exposed to the atmosphere condenses to turn into white smoke. The white smoke is formed of extremely fine water droplets. The silencer 120 reduces noise involved in discharging of the exhaust gas. The discharge port 130, through which the exhaust gas is discharged to the atmosphere, is disposed on the under floor 18 of the vehicle 10. In the present embodiment, the exhaust gas is guided by the guiding section 140 to by more on the rearward side than the rear wheel axle 14 of the vehicle 10. In the present embodiment, the guiding section 140 has a nozzle with an outlet 141 the opening area of which can be changed by the actuator 142. The outlet 141 of the guiding section 140 is open toward the rearward side of the vehicle 10. Thus, the exhaust gas is discharged toward the rearward side of the vehicle 10. Here, “the outlet 141 of the guiding section 140 faces rearward” means that the outlet 141 is oriented to be visible when the guiding section 140 is viewed from the rearward side of the vehicle 10. The outlet 141 can be set to be oriented in any direction without departing from the common sense of a person skilled in the art. Thus, the orientation is not limited to directly rearward, and the outlet 141 may be oriented somewhat leftward, rightward, upward, or downward. For example, the outlet 141 may be oriented in any direction within a Π steradian range with the directly rearward direction from the vehicle 10 at the center. The outlet 141 oriented downward relative to the directly rearward direction can achieve a lower risk of condensation on the rear under cover 17r or the like. The controller 20 issues an instruction to the actuator 142, based on the speed of the vehicle 10 obtained from the speed meter 16, to change the opening area of the outlet 141 of the guiding section 140. How the opening area of the outlet 141 of the guiding section 140 is changed is described later.

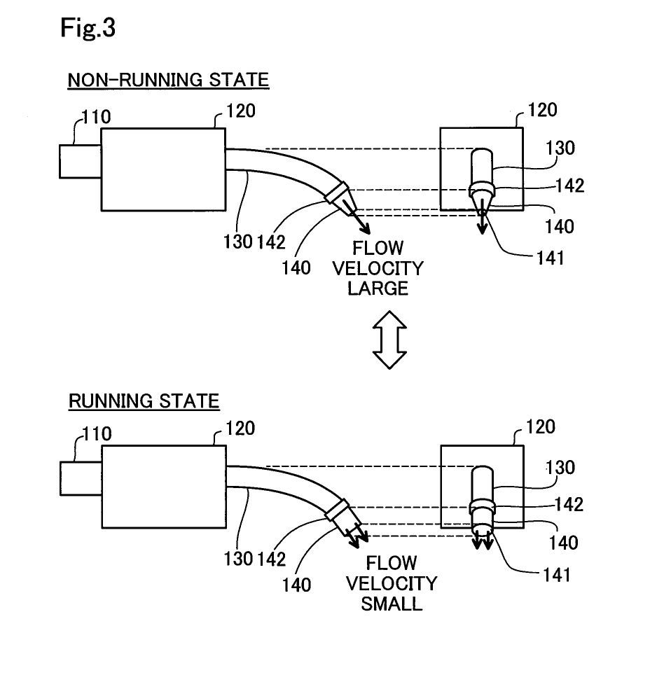

FIG. 3 is a diagram illustrating difference in the shape of the guiding section 140 between a non-running state and a running state of the vehicle 10. When the vehicle 10 is in the running state, the guiding section 140 is in a cylindrical form to have the width of the outlet 141 being substantially the same as that on the upstream side. When the vehicle 10 is in the non-running state, the guiding section 140 has a substantially conical shape to have the opening area of the outlet 141 being smaller than that on the upstream side. A constant flowrate of the exhaust gas satisfies a continuity equation “A·V=constant” between an opening area A of the outlet 141 and a flow velocity V. Thus, when the exhaust gas flows at a constant flowrate, the flow velocity of the exhaust gas increases as the opening area of the outlet 141 decreases as a result of the change in the shape of the guiding section 140 from the cylindrical shape into the substantially conical shape. The increase in the flow velocity of the exhaust gas facilitates the exhaust gas to flow further toward the rearward side of the vehicle 10. The present inventors have conducted an experiment involving a change in the flow velocity of the exhaust gas, to find out that the exhaust gas can flow toward the rearward side of the vehicle 10 as long as the flow velocity of the exhaust gas in the directly rearward direction of the vehicle 10 is 2 m/s or larger relative to the speed of the vehicle 10.

For example, the flow velocity V of the exhaust gas is 5 m/s when the flowrate of the exhaust gas in the running state is 60 L/s (60×10⁻³ m³/s) and the opening area A of the outlet 141 of the guiding section 140 is 120 cm² (12×10⁻³ m²). This value exceeds the minimum value (2 m/s) of the flow velocity enabling the exhaust gas to flow toward the rearward side of the vehicle 10. Thus, the exhaust gas with such a flow velocity is likely to flow toward the rearward side of the vehicle 10 and is less likely to spread from sides of the vehicle 10. In the actual running state, a wind flow based on vehicle speed (10 m/s, that is, 36 km/h) is added to the flow velocity. When the vehicle 10 is in the running state, the exhaust gas flows toward the rearward side of the vehicle 10 mainly due to the wind flow, rather than due to the flow velocity of the exhaust gas. The expression “the exhaust gas flows toward the rearward side of the vehicle 10” corresponds to how the exhaust gas flows as viewed from the vehicle 10. Thus, in an actual sense, the exhaust gas may be regarded as flowing rearward relative to the vehicle 10, as viewed from the vehicle 10, because the vehicle 10 is moving forward.

The vehicle 10 in the non-running state requires a small amount of power and thus generates a small amount of power. For example, when the flowrate of the exhaust gas in this state is 1 L/s (1×10⁻³ m³/s), the flow velocity V of the exhaust gas is approximately 0.083 m/s which is smaller than the minimum value (2 m/s) of the flow velocity enabling the exhaust gas to flow toward the rearward side of the vehicle 10. Thus, the exhaust gas under such a condition is less likely to flow toward the rearward side of the vehicle 10. Thus, the exhaust gas might stay below the rear under cover 17r. As a result, the tires might get wet due to the condensation of the water vapor in the exhaust gas. The water vapor in the exhaust gas partially spreads upward from the side surfaces of the vehicle 10. In this process, the water vapor condenses to turn into the white smoke. The white smoke appears to be spreading from the side surfaces of the vehicle 10. The water vapor spreads upward because the water vapor has a molecular weight (18) smaller than an average molecular weight (28.8) of air. The white smoke thus rising from the side surfaces of the vehicle 10 might make the driver or the like feel uncomfortable even when the vehicle 10 is under no failure or trouble. Thus, there has been a request for favorably discharging the exhaust gas both in the running state and in the non-running state of the vehicle 10.

In the present embodiment, the controller 20 reduces the opening area of the outlet 141 of the guiding section 140 from 120 cm² (12×10⁻³ m²) to be 5 cm² (0.5×10⁻³ m²) when the vehicle 10 is in the non-running state. Thus, the controller 20 can increase the flow velocity V of the exhaust gas to approximately 2 m/s. As a result, the condition for enabling the white smoke, generated from the water vapor in the exhaust gas, to flow toward the rearward side of the vehicle 10 can be satisfied (flow velocity of 2 m/s or larger can be achieved).

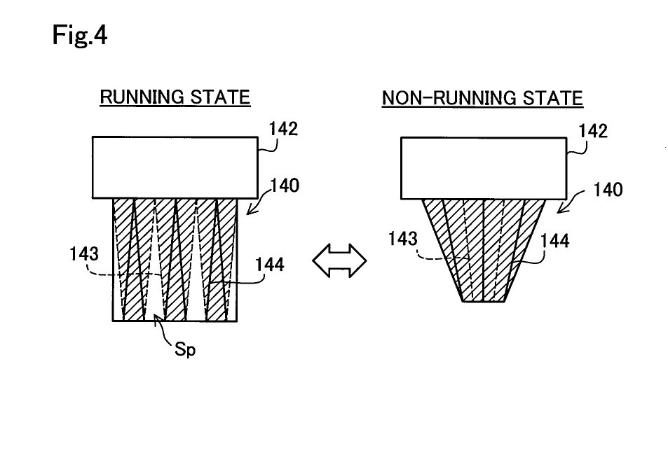

FIG. 4 is a diagram illustrating an example of a configuration for changing the shape of the guiding section 140. The guiding section 140 includes a nozzle having inner blades 143 and outer blades 144. The inner blades 143 and the outer blades 144 each have a substantially trapezoidal shape tapered toward the outlet 141. The inner blades 143 and the outer blades 144 are alternately arranged along a cylindrical plane to be overlapped with each other. In FIG. 4, the inner blades 143 are hatched, and the outer blades 144 are not hatched, for the sake of illustration.

When the vehicle 10 is in the running state, the inner blades 143 and the outer blades 144 form a substantially cylindrical nozzle as described below. The inner blades 143 are arranged along the cylindrical plane. The inner blades 143 each have a substantially trapezoidal shape tapered toward the outlet 141. Thus, a space Sp is produced between leg portions of each two adjacent ones of the inner blades 143 in the trapezoidal shape separated from each other. The outer blades 144 also have a substantially trapezoidal shape tapered toward the outlet 141, and are arranged along the cylindrical plane to fill the space Sp between the leg portions of each two adjacent ones of the inner blades 143 in the trapezoidal shape. Thus, the inner blades 143 and the outer blades 144 form the substantially cylindrical nozzle.

When the vehicle 10 is in the non-running state, the inner blades 143 and the outer blades 144 form a substantially conical shape tapered toward the outlet 141 of the guiding section 140 as described below. The actuator 142 makes the inner blades 143 inclined to have the outlet side portions moved inward until the leg portions of each two adjacent ones of the inner blades 143 in the trapezoidal shape come into contact with each other. As a result, the inner blades 143 form a substantially conical shape tapered toward the outlet 141. The actuator 142 may make the outer blades 144 inclined in a similar manner.

In the configuration according to the present embodiment, the guiding section 140 has the inner blades 143 and the outer blades 144, and the inner blades 143 are inclined. Alternatively, a configuration employing blades that slide as in a diaphragm of a camera may be employed instead of the inner blades 143 and the outer blades 144.

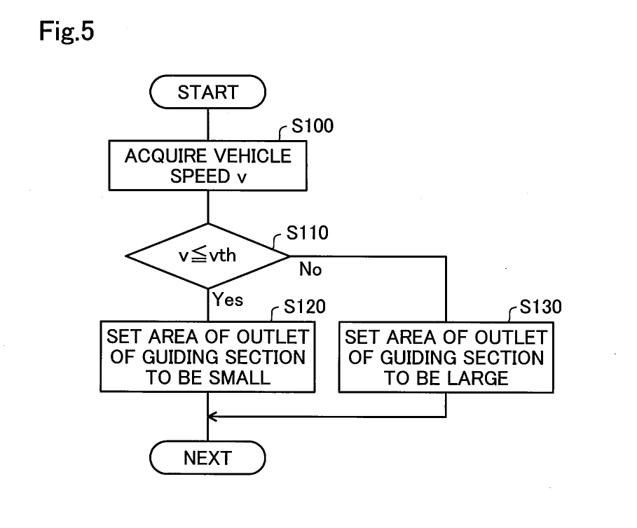

FIG. 5 is a flowchart illustrating control according to the present embodiment. Processing illustrated in FIG. 5 is repeated to be executed once in every predetermined period of time, while the fuel cell module 100 is generating power. In step S100, the controller 20 of the vehicle 10 acquires a speed v of the vehicle 10 from the speed meter 16.

In step S110, the controller 20 determines whether the speed v is equal to or lower than a predetermined speed vth. As described above, the speed vth is a predetermined value not higher than 10 km/h for example, and is preferably a value that is lower than 7.2 km/h (2 m/s). When speed v≤vth holds true, the controller 20 proceeds to processing in step S120. When speed v>vth holds true, the controller 20 proceeds to processing in step S130.

In step S120, the controller 20 instructs the actuator 142 to reduce the opening area of the outlet 141 of the guiding section 140. Thus, the actuator 142 reduces the opening area of the outlet 141 of the guiding section 140. In step S130, the controller 20 instructs the actuator 142 to increase the opening area of the outlet 141 of the guiding section 140. Thus, the actuator 142 increases the opening area of the outlet 141 of the guiding section 140. Then, when a predetermined period of time elapses, the controller 20 proceeds to the processing in step S100 in the next cycle.

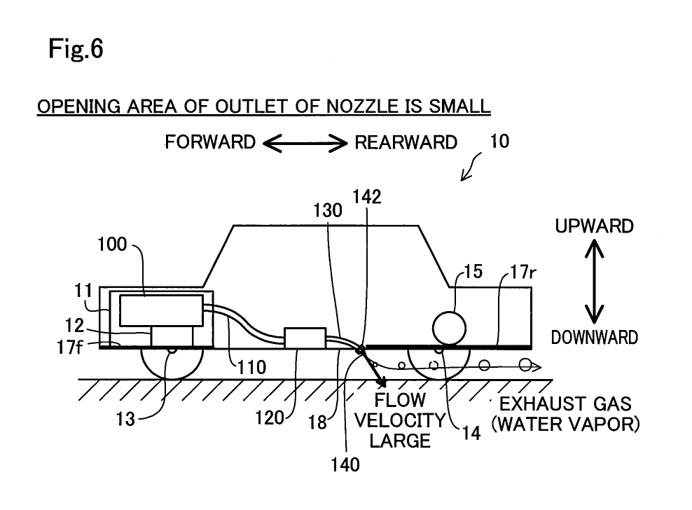

FIG. 6 is a diagram illustrating how the exhaust gas flows when the opening area of the outlet 141 of the guiding section 140 is small. When the vehicle 10 is in the non-running state with the speed v not exceeding the predetermined speed vth, the controller 20 instructs the actuator 142 to reduce the opening area of the outlet 141 of the guiding section 140. As a result, the flow velocity V of the exhaust gas discharged toward the rearward of the vehicle 10 from the outlet 141 of the guiding section 140 increases, so that the exhaust gas flows toward the rearward side of the vehicle 10. Thus, the white smoke, as a result of the condensation of the water vapor in the exhaust gas, flows toward the rearward side of the vehicle 10. Thus, the controller 20 can make the white smoke, as a result of the condensation of the water vapor, flow toward the rearward side of the vehicle 10, by making the actuator 142 reduce the opening area of the outlet 141 of the guiding section 140 to increase the flow velocity V of the exhaust gas discharged toward the rearward side of the vehicle 10. In this manner, when the vehicle 10 is in the non-running state with the speed v not exceeding the predetermined speed vth, the opening area of the outlet 141 of the guiding section 140 is set to be small by the actuator 142 so that the flow velocity V of the exhaust gas is set to be high for enabling the exhaust gas to flow rearward. The water vapor in the exhaust gas may condense to turn into the white smoke. Still, the white smoke is discharged rearward to be dispersed while traveling from the guiding section 140 to the rear end of the vehicle 10, and thus is less likely to be observed as a large mass of smoke. The white smoke being discharged and spreading from the rear end of the vehicle 10 does not appear to be unnatural. Thus, the driver or the like is less likely to feel uncomfortable or doubt that some trouble has occurred.

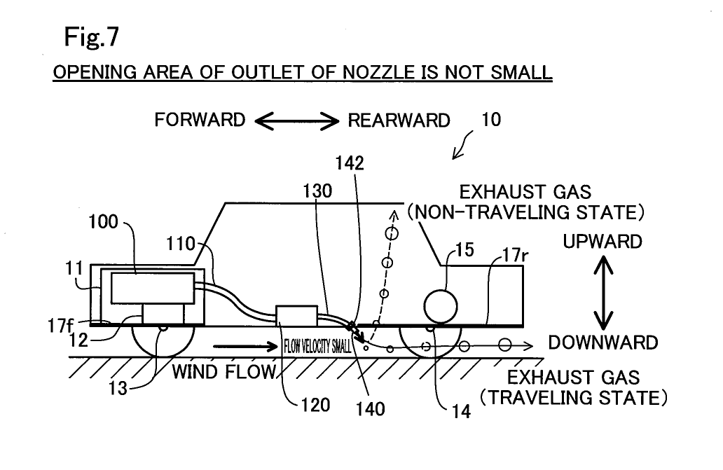

FIG. 7 is a diagram illustrating how the exhaust gas flows when the opening area of the outlet 141 of the guiding section 140 is not small. When the opening area of the outlet 141 of the guiding section 140 is not small, the flow velocity V of the exhaust gas is low. Still, if the vehicle 10 is in the running state, the exhaust gas flows toward the rearward side of the vehicle 10 due to the wind flow. The water vapor in the exhaust gas may condense to turn into the white smoke. Still, the white smoke is discharged rearward to be dispersed while traveling from the guiding section 140 to the rear end of the vehicle 10, and thus is less likely to be observed as a large mass of smoke. The white smoke being discharged and spreading from the rear end of the vehicle 10 does not appear to be unnatural. Thus, the driver or the like is less likely to feel uncomfortable or doubt that some trouble has occurred. FIG. 7 is a reference diagram illustrating how the exhaust gas flows when the opening area of the outlet 141 is not small while the vehicle 10 is in the non-running state. This state involves a small flow velocity V of the exhaust gas and does not involve the wind flow, and thus results in the exhaust gas spreading from the under floor 18 and the side surfaces of the vehicle 10 instead of flowing toward the rearward side of the vehicle 10.

In the present embodiment described above, the controller 20 uses the actuator 142 to set the opening area of the outlet 141 of the guiding section 140 in the non-running state of the vehicle 10 to be smaller than that of the outlet 141 in the running state. Thus, the flow velocity V of the exhaust gas can be increased to make the exhaust gas flow toward the rearward side of the vehicle 10. In the running state, the exhaust gas can flow toward the rearward side of the vehicle 10 as viewed from the vehicle 10 due to the wind flow. Thus, the exhaust gas can be favorably discharged both in the running state and the non-running state of the vehicle 10.

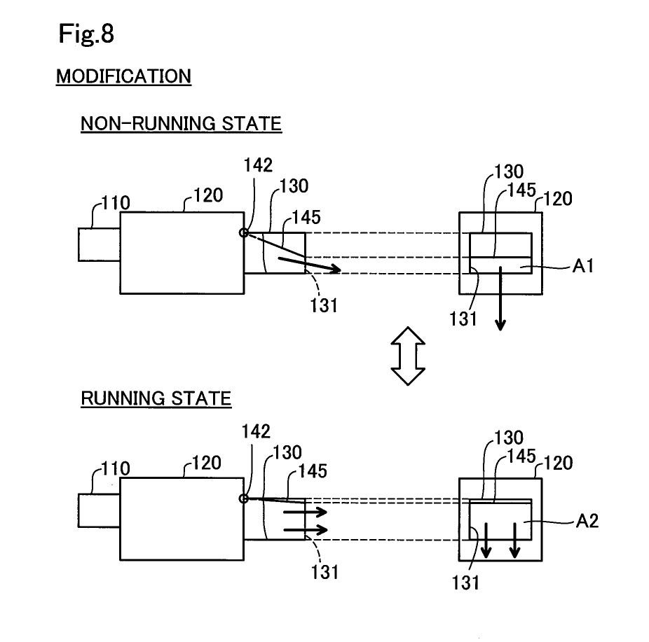

FIG. 8 is a diagram illustrating a modification featuring a different way to change the opening area of the outlet of the discharge port. An exhaust gas guiding section according to this embodiment includes the discharge port 130 and a valve 145. A valve 145 is provided inside the discharge port 130. The valve 145 is rotatably fixed to the silencer 120, and is rotated by the actuator 142 to change the opening area of an outlet 131 of the discharge port 130. Thus, the controller 20 uses the actuator 142 to rotate the valve 145 to set an opening area A1 of the outlet 131 when the vehicle 10 is in the non-running state. The opening area A1 is smaller than an opening area A2 set when the vehicle 10 is in the running state. The opening area A1 of the outlet 131 is set to make the exhaust gas discharged from a discharge port 134 at the flow velocity V of approximately 2 m/s or higher while the vehicle 10 is in the non-running state. Thus, the controller 20 can set the opening area A1 of the outlet 131 of the discharge port 130 in the vehicle 10 in the non-running state to be smaller than the opening area A2 of the outlet 131 in the vehicle 10 in the running state, as in the first embodiment. Thus, a large flow velocity V of the exhaust gas can be achieved, and the exhaust gas can flow toward the rearward side of the vehicle 10. While the vehicle 10 is in the running state, the exhaust gas can flow toward the rearward side of the vehicle 10 as viewed from the vehicle 10, due to the wind flow. All things considered, the exhaust gas can be favorably discharged while the vehicle 10 is in the running state and in the non-running state.

In the present embodiment, the discharge port 130 has a substantially cylindrical shape, and the valve 145 may be arranged along the inner cylindrical surface of the discharge port 130. When the vehicle 10 is in the non-running state, the valve 145 is inclined toward the inner side to narrow the outlet 131. When the vehicle 10 is in the running state, the valve 145 spreads to extend along the inner cylindrical surface of the discharge port 130, so that the outlet 131 can be widened.

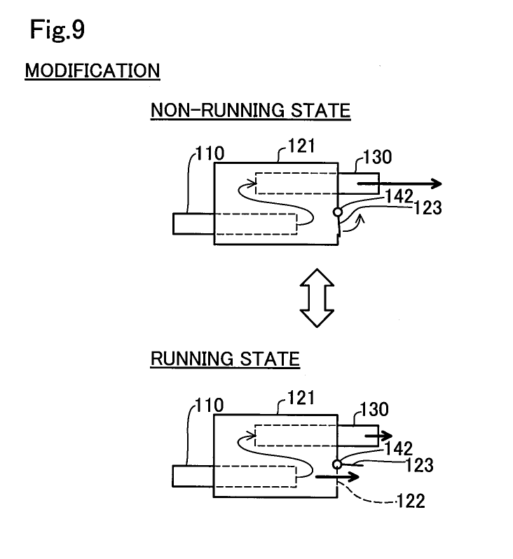

FIG. 9 is a diagram illustrating another modification featuring a different way to change the opening area of the outlet of the discharge port. In this embodiment, the vehicle 10 includes a silencer 121 and the discharge port 130. The silencer 121 includes an opening 122, a lid 123 for opening and closing the opening 122, and the actuator 142 that opens and closes the lid 123, and serves as a guiding section. The discharge port 130 has an opening area enabling the exhaust gas to be discharged at a flow velocity of approximately 2 m/s or higher from the discharge port 130 while the vehicle 10 is in the non-running state.

When the vehicle 10 is in the non-running state, the controller 20 uses the actuator 142 to close the lid 123, so that the exhaust gas is discharged, from the discharge port 130, at the flow velocity V of approximately 2 m/s or higher. When the vehicle 10 is in the running state, the controller 20 uses the actuator 142 to open the lid 123, so that the exhaust gas is discharged from the discharge port 130 and the opening 122. Thus, the exhaust gas can be favorably discharged while the vehicle 10 is in the running state and in the non-running state, as in the first embodiment. In this embodiment, how the exhaust gas is discharged can be switched between the running state and the non-running state of the vehicle 10, with a simple configuration of providing the lid 123 to the silencer 121. Thus, the exhaust gas can be favorably discharged in both states. In the present embodiment, the lid 123 having an end connected to the actuator 142 is used. Alternatively, a butterfly valve may be used instead of the lid 123. In such a configuration, the opening 122 can be easily opened and closed through axial rotation of the butterfly valve.

### Second Embodiment

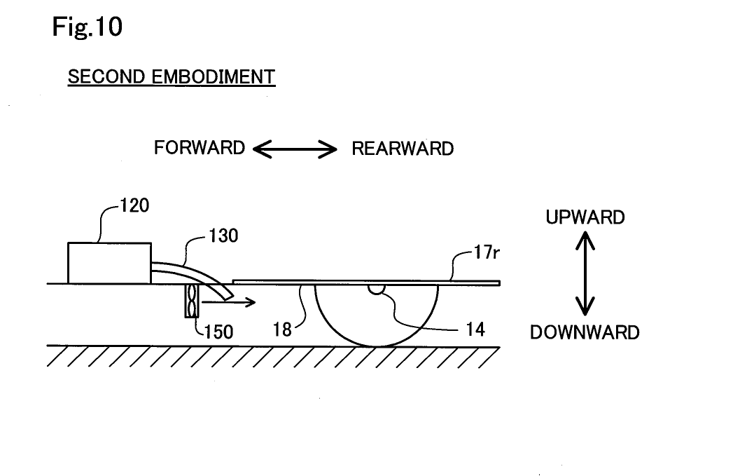

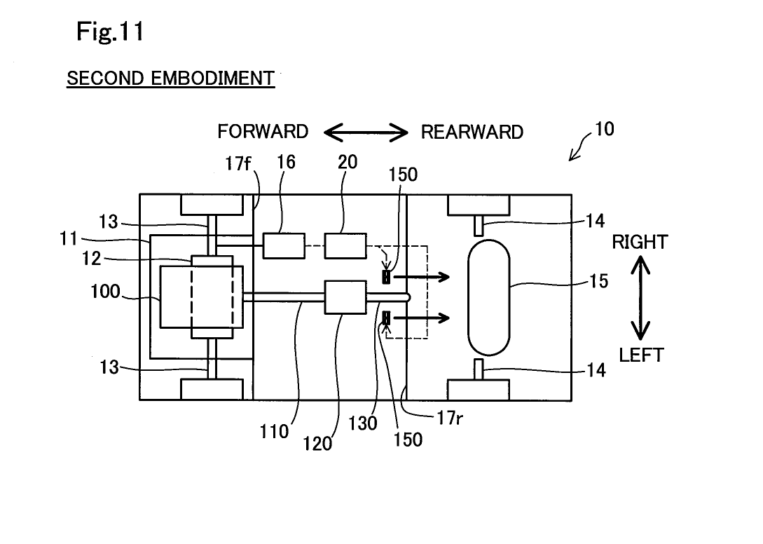

FIG. 10 and FIG. 11 are each a diagram illustrating a schematic configuration of the vehicle 10 according to the second embodiment. The vehicle 10 according to the second embodiment has fans 150 on the under floor 18. In the present embodiment, the fans 150 are provided left and right of the discharge port 130, and create an air flow from the forward side toward the rearward side of the vehicle 10. The controller 20 drives and rotates the fans 150 based on the speed v of the vehicle 10. Specifically, the fans 150 are driven in the non-running state with the speed of the vehicle 10 not exceeding vth, and are not driven in the running state with the speed exceeding vth. The exhaust gas discharged from the discharge port 130, while the vehicle 10 is in the non-running state, spreads in left and right directions of the vehicle 10. The exhaust gas that has reached the air flow created by the fans 150 has the flow velocity toward the rearward side of the vehicle 10 increased, and thus moves toward the rearward side of the vehicle 10. While the vehicle 10 is in the running state, the exhaust gas moves toward the rearward side of the vehicle 10 due to the wind flow, and thus the controller 20 does not need to drive the fans 150. Thus, the controller 20 drives and rotates the fans 150 while the vehicle 10 is in the non-running state, and does not drive the fans 150 while the vehicle 10 is in the running state, whereby the exhaust gas can be favorably discharged in both of the running state and the non-running state of the vehicle 10, as in the first embodiment. The controller 20 may drive the fans 150 also while vehicle 10 is in the running state, based on the speed of the vehicle 10. Specifically, the fans 150 may be driven with a fan driving amount decreasing as the speed of the vehicle 10 increases.

In the present embodiment, the fans 150 are disposed left and right of the discharge port 130. Alternatively, the fan 150 may be disposed more on the forward or the rearward side than the discharge port 130. The fan 150 disposed more on the forward side than the discharge port 130 is free of water vapor in the exhaust gas, and thus is less likely to deteriorate. The fan 150 disposed more on the rearward side than the discharge port 130 sucks the exhaust gas and can more efficiently send wind than the fan 150 disposed more on the forward side than the discharge port 130. The fans 150 disposed left and right of the discharge port 130 as in the present embodiment are free of the water vapor in the exhaust gas, and thus are less likely to deteriorate. Furthermore, the fans 150 can prevent the exhaust gas, which would otherwise spread left and right of the vehicle 10, from spreading left and right. This ensures that the exhaust gas is prevented from spreading through the under floor 18 and the side surfaces of the vehicle 10.

The white smoke, produced while the fuel cell module is generating power, might spread to be close to a door or a window. When the door or the window is open, the white smoke might enter the vehicle through the door or the window. Thus, the fans 150 may rotate at a higher speed in a situation where the door or the window is open than in a situation where the door or the window is closed.

### Third Embodiment

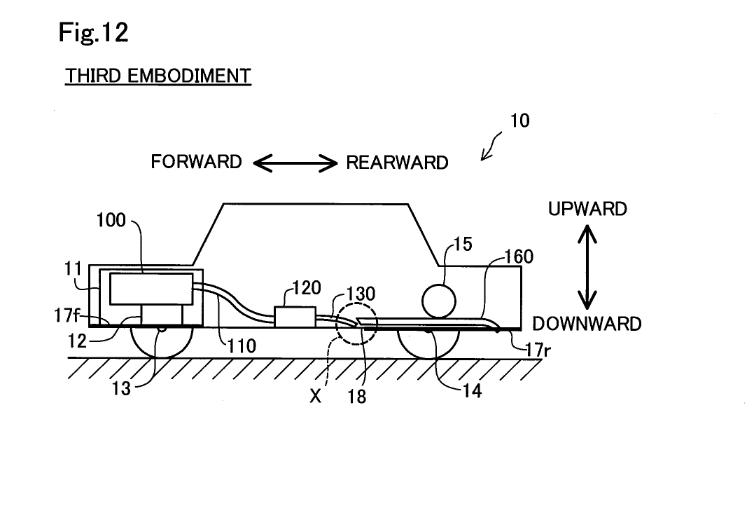

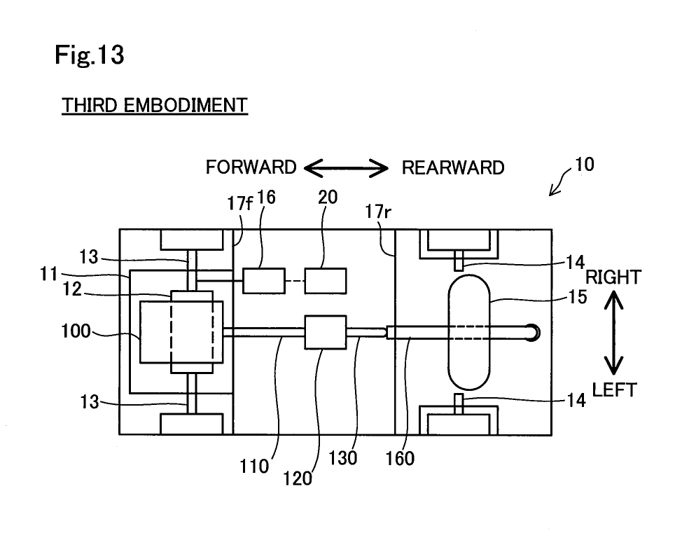

FIG. 12 and FIG. 13 are each a diagram illustrating a schematic configuration of the vehicle 10 according to the third embodiment. In the vehicle 10 of the third embodiment, a duct 160 is provided as a guiding section. In this embodiment, the duct 160 has, for example, a cylindrical shape. The duct 160 has a cross-sectional area that is larger than an opening area of the outlet of the discharge port 130. The duct 160, extending to a rear portion of the vehicle 10, has an inlet covering the outlet of the discharge port 130 from an upward side in the vertical direction. The duct 160 has an outlet provided more on the rearward side than the rear wheel axle 14 of the vehicle 10. In the present embodiment, the duct 160 is provided above the rear under cover 17r of the vehicle 10. Trash and dust are less likely to enter the duct 160 above the rear under cover 17r, and thus the duct 160 is less likely to be clogged. In the present embodiment, the duct 160 has a shape linearly extending toward the rearward side of the vehicle 10. Alternatively, the shape may not be linear. The fuel tank 15 has both ends each having a dome shape. Thus, the duct 160 may be curved to be provided between the dome shaped portion and the rear under cover 17r. With this configuration, the fuel tank 15 can be positioned more on the downward side, so that the vehicle 10 can have a lower center of gravity.

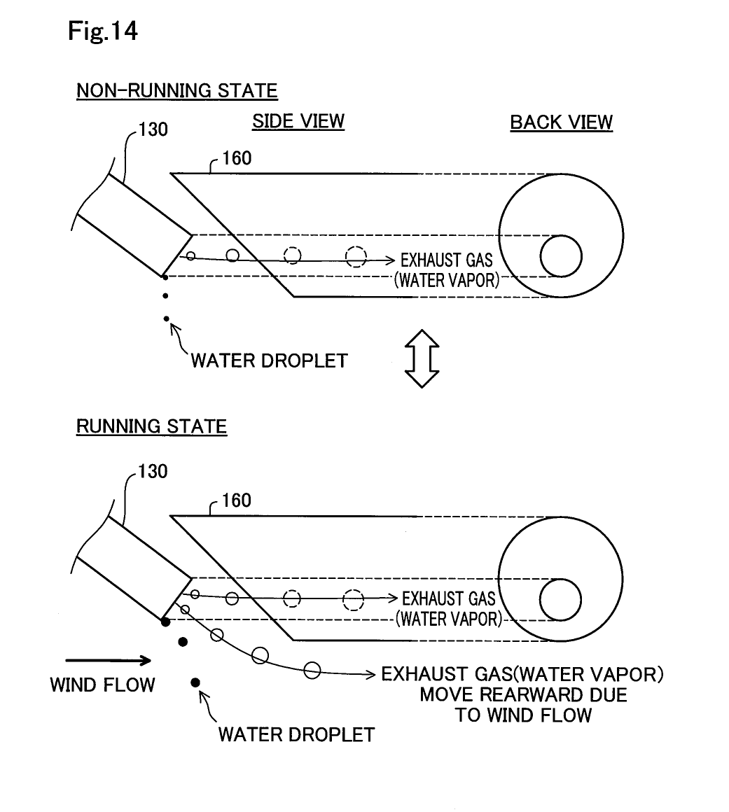

FIG. 14 is a diagram illustrating how the exhaust gas flows in an area X in FIG. 12, in the non-running state and in the running state. In FIG. 14, the rear under cover 17r (FIG. 12 and FIG. 13) is omitted. The amount of exhaust gas discharged from the discharge port 130 is small, while the vehicle 10 is in the non-running state. The water vapor in the exhaust gas is lighter than air. The duct 160 covers the outlet of the discharge port 130 from the upward side in the vertical direction. Thus, the exhaust gas including water vapor passes through the duct 160 to be guided to the rear portion of the vehicle 10. The water vapor in the exhaust gas may condense while the exhaust gas passes through the duct 160. When this happens, the water vapor in a liquid form can be discharged from the duct 160. The duct 160 may be inclined to be lower on the outlet side (on the rearward side of the vehicle 10) instead of being horizontal, so that the discharging of the liquid can be facilitated. Alternatively, the duct 160 may be inclined to be higher on the outlet side (on the rearward side of the vehicle 10). With this configuration, the white smoke is discharged from the rearward side of the vehicle 10, and the liquid is discharged from a portion of the vehicle 10 between the front wheel axle 13 and the rear wheel axle 14.

The amount of the exhaust gas discharged from the discharge port 130 is large when the vehicle 10 is in the running state. A part of the exhaust gas is guided, through the duct 160, to a portion of the vehicle 10 more on the rearward side than the rear wheel axle 14. The remaining exhaust gas moves rearward due to the wind flow. With this configuration, the exhaust gas can be favorably discharged in both of the running state and the non-running state of the vehicle 10, without the controller 20 performing the control for changing the flow velocity V of the exhaust gas.

In the present embodiment, the duct 160 has a cross-sectional area that is larger than the opening area of the outlet of the discharge port 130. With this configuration, the exhaust gas discharged from the discharge port 130 can be more easily collected. Still, the cross-sectional area of the duct 160 may not be larger than the opening area of the outlet of the discharge port 130. The amount of the exhaust gas spreading through the under floor 18 and the side surfaces of the vehicle 10 can be reduced with the exhaust gas discharged from the discharge port 130 guided to the duct 160, as long as the duct 160 covers the outlet of the discharge port 130 from the upward side in the vertical direction. The exhaust gas discharged from the discharge port 130 may not be completely guided to the duct 160, and may only be partially guided to the duct 160.

### Fourth Embodiment

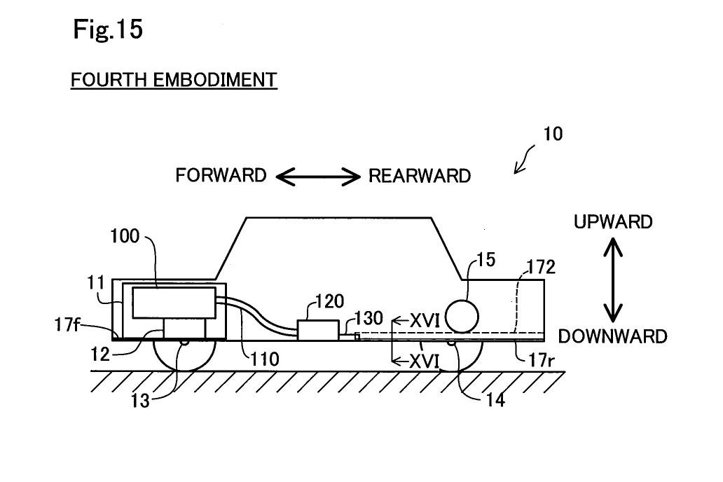

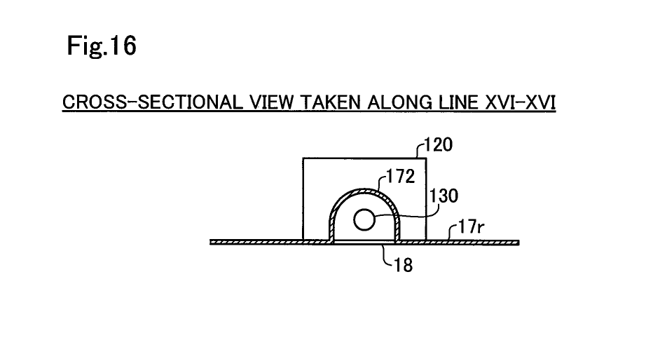

FIG. 15 is a diagram illustrating a schematic configuration of the vehicle 10 according to the fourth embodiment. FIG. 16 is a cross-sectional view taken along line XVI-XVI in FIG. 15. The vehicle 10 according to the fourth embodiment includes a groove 172 recessed upward in the vertical direction and formed on the rear under cover 17r to serve as the guiding section. The groove 172 covers the outlet of the discharge port 130 from the upward side in the vertical direction, and extends to a portion more on the rearward side of the vehicle 10 than the rear wheel axle 14. The groove 172 is larger than the discharge port 130.

The amount of exhaust gas discharged from the discharge port 130 is small, while the vehicle 10 is in the non-running state. The water vapor in the exhaust gas is lighter than air. The groove 172 covers the outlet of the discharge port 130 from the upward side in the vertical direction. Thus, the exhaust gas including the water vapor is guided along the groove 172 to a rear portion of the vehicle 10.

The amount of the exhaust gas discharged from the discharge port 130 is large when the vehicle 10 is in the running state. A part of the exhaust gas is guided, through the groove 172, to the rear portion of the vehicle 10. The remaining exhaust gas moves rearward due to the wind flow. With this configuration, the exhaust gas can be favorably discharged in both of the running state and the non-running state of the vehicle 10, without the controller 20 performing the control for changing the flow velocity of the exhaust gas. The groove 172 is open downward and thus will not be clogged by trash and dust.

In the embodiments described above, the guiding section that can guide the water vapor, discharged from the discharge port 130, to a portion more on the rearward side than the rear wheel axle 14 is provided. When the vehicle 10 is in the non-running state, the water vapor is guided through the guiding section to a portion more on the rearward side than the wheel axle 14. When the vehicle 10 is in the running state, the water vapor, discharged from the discharge port 130, at least partially flows rearward due to the wind flow. Thus, the exhaust gas can be favorably discharged in both of the running state and the non-running state of the vehicle 10.

### Fifth Embodiment

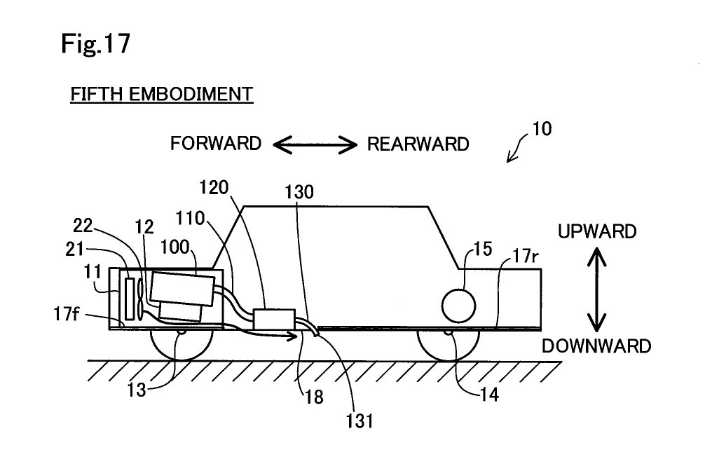

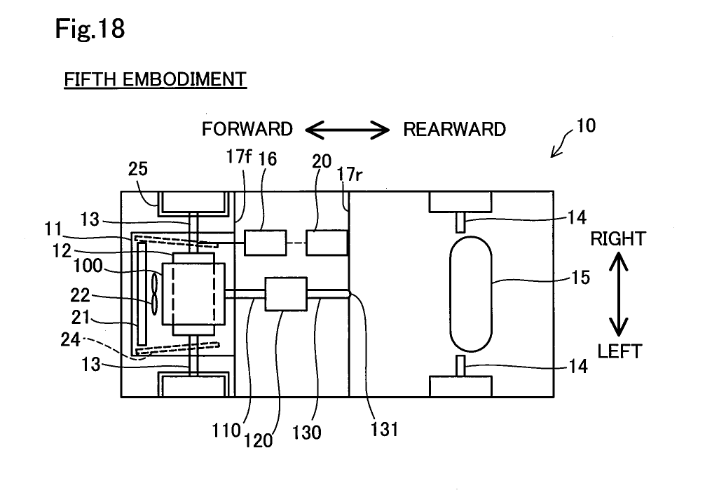

FIG. 17 and FIG. 18 are each a diagram illustrating a schematic configuration of the vehicle 10 according to a fifth embodiment. The vehicle 10 according to the fifth embodiment is different from the vehicle 10 according to the second embodiment in that a radiator 21 and a radiator fan 22 are provided and the radiator fan 22 is used for guiding the white smoke. The radiator 21 and the radiator fan 22 are disposed more on the forward side than the fuel cell module 100. The radiator 21 cools cooling liquid for cooling the fuel cell module 100. The radiator fan 22 cools the radiator 21 with air. The radiator 21 is disposed more on the forward side than the radiator fan 22 and is positioned, in the height direction, to be capable of sending air below the fuel cell module. For example, the radiator fan 22 has a lower most end positioned to be lower than a portion of the fuel cell module 100 on the forward side of the vehicle. The fuel cell module 100 is inclined to have the vehicle forward side positioned higher than the vehicle rearward side.

The radiator 21 disposed more on the forward side than the radiator fan 22 directly receives the wind flow while the vehicle 10 is in the running state. Generally, a configuration in which the radiator fan 22 sucks air from the radiator 21 can achieve higher cooling efficiency than a configuration in which the radiator fan 22 sends air to the radiator 21. This is because the former configuration enables air to more easily pass through the radiator 21. With the radiator 21 not disposed on the rearward side of the radiator fan 22, that is, on the air sending direction, the air produced by the radiator fan 22 can be more easily guided to the discharge port 130.

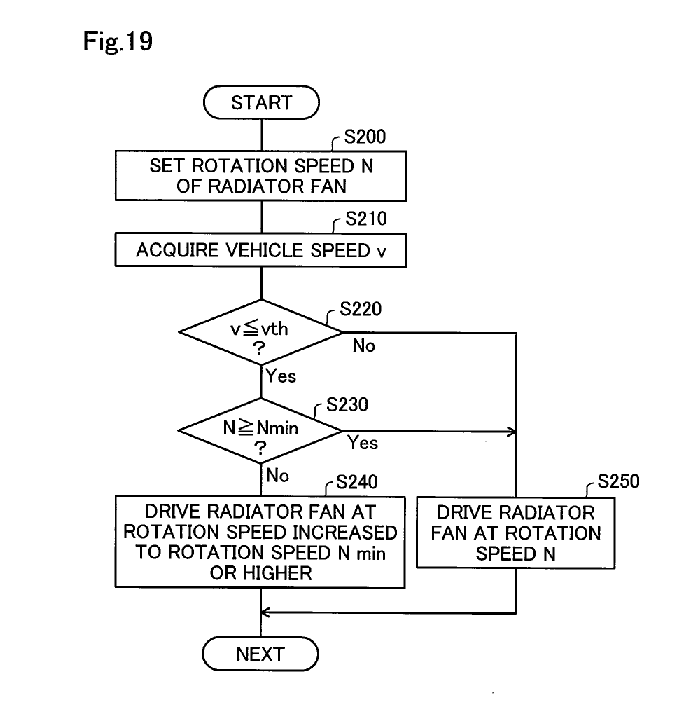

FIG. 19 is a flowchart illustrating control according to the fifth embodiment. Processing illustrated in FIG. 19 is repeated to be executed once in every predetermined period of time, while the fuel cell module 100 is generating power. In step S200, the controller 20 sets a rotation speed N of the radiator fan 22. The controller 20 sets the rotation speed N of the radiator fan 22 based on at least one of the power generation amount of the fuel cell module 100, the temperature of the cooling liquid for cooling the fuel cell module 100, and the outer temperature.

In step S210, the controller 20 of the vehicle 10 acquires the speed v of the vehicle 10 from the speed meter 16. In step S220, the controller 20 determines whether the speed v is equal to or lower than the predetermined speed vth. These processes are the same as those in steps S100 and S110 described with reference to FIG. 5. When speed v≤vth holds true, the controller 20 determines that the vehicle 10 is technically stopped, and the processing proceeds to step S230. When speed v>vth holds true, the controller 20 determines that the vehicle 10 is technically traveling, and the processing proceeds to step S250.

In step S230, the controller 20 determines whether the rotation speed N is equal to or higher than a minimum rotation speed Nmin. The minimum rotation speed Nmin corresponds to a minimum possible rotation speed with which the radiator fan 22 can guide the white smoke toward the rearward side even when the vehicle 10 is stopped (with zero speed). Thus, the white smoke can be guided toward the rearward side of the vehicle 10 even when the vehicle 10 is stopped, as long as the radiator fan 22 is rotated at the rotation speed Nmin or higher. When the rotation speed N is lower than the minimum rotation speed Nmin, the processing proceeds to step S240. When the rotation speed N is equal to or higher than the minimum rotation speed Nmin, the processing proceeds to step S250.

In step S240, the controller 20 increases the rotation speed of the radiator fan 22 up to Nmin or higher, and drives the radiator fan 22. Thus, the air is sucked by the radiator fan 22 and then flows between the fuel cell module 100 and the front under cover 17f toward the rearward side. The air is discharged below the vehicle 10 at a portion more on the front side than the discharge port 131, and flows from the front side toward the rearward side below the vehicle 10. Thus, the white smoke can be guided toward the rearward side of the vehicle 10 even when the vehicle 10 is stopped. The minimum rotation speed Nmin enables the air to flow, below the vehicle 10, at a speed of 2 m/s or higher for example when the vehicle 10 is stopped. The controller 20 may change the rotation speed Nmin based on the amount of water vapor discharged from the fuel cell module 100. The controller 20 can calculate the amount of water vapor discharged from the fuel cell module 100, based on the power generation amount of the fuel cell module 100. The minimum rotation speed Nmin may set to be different among different heights between the ground and the outlet 131 of the discharge port 130 of the vehicle 10 or among different widths of the vehicle 10.

In step S240, the controller 20 drives the radiator fan 22 to rotate at the rotation speed N that is equal to or higher than the minimum rotation speed enabling the white smoke to be guided to the rearward side of the vehicle 10 even when the vehicle 10 is stopped. Thus, the white smoke can be guided toward the rearward side of the vehicle 10. Then, when a predetermined period of time elapses, the processing executed by the controller 20 returns to step S200.

In step S250, the controller 20 drives the radiator fan 22 to rotate at the rotation speed N. Then, when a predetermined period of time elapses, the processing executed by the controller 20 returns to step S200. When the vehicle 10 is at a speed higher than Vth, that is, when the vehicle 10 is in the running state, the wind flow is added to the air flow. The resultant air flow functions in a manner similar to that of the air flow created by the fans 150 according to the second embodiment. The rotation speed of the radiator fan 22 may be maintained at the rotation speed N.

In the fifth embodiment described above, the exhaust gas can be favorably discharged in both of the running state and the non-running state of the vehicle 10. In the fifth embodiment, the air flow created by the radiator fan 22 is used so that a new component is not required unlike in the second embodiment.

In the fifth embodiment, the front under cover 17f, provided on the downward side of the front room 11 in the vertical direction may be omitted. In this configuration, the air flows on the downward side of the fuel cell module 100 in the vertical direction, that is, between the fuel cell module 100 and the ground. In the configuration without the front under cover 17f, the radiator fan 22 may rotate at a higher rotation speed when the vehicle 10 is stopped, than in the configuration with the front under cover 17f.

In the fifth embodiment, the fuel cell module 100 is inclined to have the front portion positioned higher than the rear portion. This configuration achieves air guiding effect that facilitates the air flow between the fuel cell module 100 and the front under cover 17f or the ground. The fuel cell module 100 may not be inclined as long as the air can flow below the fuel cell module 100.

The white smoke, produced while the fuel cell module is generating power, might spread to be close to a door or a window. When the door or the window is open, the white smoke might enter the vehicle through the door or the window. Thus, the radiator fan 22 may rotate at a higher speed in a situation where the door or the window is open than in a situation where the door or the window is closed.

In the fifth embodiment, partitions 24, substantially in parallel with the front and rear direction of the vehicle 10, may be provided on a side of the front under cover 17f closer to a motor room 11. Thus, the air flows along the partitions 24 so as not to spread left and right of the vehicle 10. The partitions 24 may be omitted. The air from the radiator fan 22 may be guided along inner sides of a tire house 25, instead of being guided by the partitions 24.

The radiator fan 22 disposed more on the reward side than the radiator 21 in the fifth embodiment, may also be disposed more on the forward side than the radiator 21. The radiator fan 22 can send air toward the rearward side of the vehicle 10, regardless of whether the radiator fan 22 is positioned more on the forward or the rearward side than the radiator 21. The white smoke can be guided toward the rearward side of the vehicle 10 with the air flow thus produced.

The radiator 21 and the radiator fan 22 are not mentioned in the first to the fourth embodiments. Note that the radiator 21 and the radiator fan 22 may also be provided to cool the fuel cell module 100 in these embodiments.

In the embodiments described above, the under cover is divided into the front under cover 17f and the rear under cover 17r. Alternatively, the front under cover 17f and the rear under cover 17r may be integrated to be a single member provided with an opening through which the discharge port 130 and the like pass.

The configurations in the embodiments described above may each be implemented independently or may be implemented in combinations. For example, a combination between the first embodiment and the second embodiment, a combination between the first embodiment and the third embodiment, a combination between the first embodiment and the fourth embodiment, a combination between the first embodiment and the fifth embodiment, a combination between the second embodiment and the third embodiment, a combination between the second embodiment and the fourth embodiment, a combination among the first embodiment, the second embodiment, and the third embodiment, and a combination among the first embodiment, the second embodiment, and the fourth embodiment may be implemented. The third embodiment and the fourth embodiment may be combined with the duct 160 disposed in at least a part of the groove 172. Note that the combinations listed above are merely examples, and the possible combination is not limited to these.

In the first embodiment, the flow velocity of the exhaust gas is changed by changing the area of the outlet 141 of the guiding section 140. Alternatively, the orientation of the exhaust gas discharged from the guiding section 140 may be changed. For example, the outlet 141 of the guiding section 140 may face directly rearward from the vehicle 10 in the non-running state, and may face more downward in the running state than in the non-running state.

The value of the flow velocity described above is merely an example. Thus, the flow velocity achieved by the guiding section 140, in the non-running state, varies depending on the entire length, the width, the minimum height from the ground, or the like of the vehicle 10. A suitable value for each mode of the vehicle 10 may be obtained through experiments, for example.

The invention is not limited to the embodiments and the modifications described above but may be implemented by a diversity of other configurations without departing from the scope of the invention. For example, the technical features of any of the above embodiments and its modifications corresponding to the technical features of each of the aspects described in Summary may be replaced or combined appropriately, in order to solve part or all of the problems described above or in order to achieve part or all of the advantageous effects described above. Any of the technical features may be omitted appropriately unless the technical feature is described as essential in the description hereof.

### Other Embodiments

The present disclosure is enabled to be realized as the following aspects.

According to an aspect of the present disclosure, a fuel cell vehicle is provided. The fuel cell vehicle comprises a fuel cell module, a discharge port through which exhaust gas including water produced in the fuel cell module is discharged, the discharge port being disposed on an under floor and between a front wheel axle and a rear wheel axle of the fuel cell vehicle, and a guiding section capable of guiding the exhaust gas to flow toward a rearward side beyond the rear wheel axle while the fuel cell vehicle is in a non-running state.

With this aspect, the exhaust gas including water (water vapor) can be guided by the guiding section to flow toward the rearward side beyond the rear wheel axle, while the fuel cell vehicle is in the non-running state. This ensures a lower risk of the rear wheels coming into contact with or getting wet by the water vapor. White smoke, as a result of condensation of the water vapor, does not spread from side surfaces of the fuel cell vehicle. Thus, the exhaust gas can be favorably discharged while the fuel cell vehicle is in the non-running state.

In the above-described aspect, the fuel cell vehicle may further comprise a speed meter, and a controller that controls the guiding section in accordance with speed of the fuel cell vehicle. The guiding section may include an outlet of the discharge port, and the controller may reduce an opening area of the outlet when the fuel cell vehicle is in the non-running state to be smaller than the opening area when the fuel cell vehicle is in a running state.

With this aspect, the controller sets the opening area of the guiding section to be smaller in the non-running state of the fuel cell vehicle than in the running state. Thus, the exhaust gas can be guided by the guiding section to flow toward the rearward side beyond the rear wheel axle, even when the fuel cell vehicle is in the non-running state.

In the above-described aspect, the guiding section may include a nozzle having an outlet an opening area of which is controllable, the nozzle being provided to the discharge port, and the controller may reduce the opening area of the outlet when the fuel cell vehicle is in the non-running state to be smaller than the opening area of the outlet when the fuel cell vehicle is in the running state.

With this aspect, the controller sets the opening area of the outlet of the discharge port in the non-running state of the fuel cell vehicle to be smaller than that in the running state of the fuel cell vehicle. Thus, a flow velocity of the exhaust gas discharged from the discharge port can be increased. Thus, the exhaust gas can move toward the rearward side of the fuel cell vehicle while the fuel cell vehicle is in the non-running state.

In the above-described aspect, the guiding section may comprise a silencer provided between the fuel cell module and the discharge port, an opening through which the exhaust gas is discharged from the fuel cell vehicle without passing through the discharge port, and a lid with which the opening is opened and closed, the discharge port may have an opening area enabling the exhaust gas to flow at a flow velocity equal to or higher than a predetermined flow velocity to be discharged even when the fuel cell vehicle is in the non-running state, and the controller may control the lid to be closed when the fuel cell vehicle is in the non-running state, and to be opened when the fuel cell vehicle is in the running state.

With this aspect, the controller closes the lid while the fuel cell vehicle is in the non-running state, so that the exhaust gas, discharged from the discharge port, can move toward the rearward side of the fuel cell vehicle at the increased flow velocity.

In the above-described aspect, the guiding section may further comprise a fan, and the controller may drive the fan at least when the fuel cell vehicle is in the non-running state to guide the exhaust gas toward the rearward side of the fuel cell vehicle.

With this aspect, the controller drives the fan while the fuel cell vehicle is in the non-running state, so that the exhaust gas can be guided toward the rearward side of the fuel cell vehicle at the increased flow velocity.

In the above-described aspect, the fuel cell vehicle may further, comprise a speed meter, and a controller that controls the guiding section in accordance with speed of the fuel cell vehicle, the guiding section may comprise a fan, and the controller may drive the fan at least when the fuel cell vehicle is in the non-running state to guide the exhaust gas toward the rearward side of the fuel cell vehicle.

With this aspect, the controller drives the fan while the fuel cell vehicle is in the non-running state, so that the exhaust gas can be guided toward the rearward side of the fuel cell vehicle at the increased flow velocity.

In the above-described aspect, the fuel cell vehicle may further comprise a radiator that cools the fuel cell module, and

a radiator fan that cools the radiator with air, and the radiator fan may be used as a fan for the guiding section.

With this aspect, the radiator fan is used as the fan of the guiding section, so that the exhaust gas can be guided toward the rearward side of the fuel cell vehicle at the increased flow velocity while the fuel cell vehicle is in the non-running state, with no additional component required.

In the above-described aspect, the fuel cell module may be inclined to have a vehicle forward side disposed higher than a vehicle rearward side, and the radiator fan may be disposed more on the forward side than the fuel cell module and is positioned, in a height direction, to be capable of sending air below the fuel cell module.

With this aspect, the fuel cell module is inclined to have the forward side disposed higher than the rearward side, and the radiator fan is disposed more on the forward side than the fuel cell module and is positioned, in the height direction, to be capable of sending air below the fuel cell module. Thus, the air flow created by the radiator fan can be guided to the discharge port while passing through a portion below the fuel cell module in a vertical direction.

In the above-described aspect, the fuel cell vehicle may further comprise an under cover disposed below the radiator fan and the fuel cell module in a vertical direction.

With this aspect, the under cover is disposed below the radiator fan and the fuel cell module in the vertical direction. Thus, the air flow created by the radiator fan is guided to the discharge port while passing between the fuel cell module and the under cover.

In the above-described aspect, the guiding section may comprise a duct disposed more on the rearward side than the discharge port, the duct may have an inlet covering the discharge port from an upward side in a vertical direction, and the duct may have an outlet disposed more on the rearward side than the rear wheel axle.

With this aspect, the exhaust gas is guided through the duct to flow toward the rearward side beyond the rear wheel axle, while the fuel cell vehicle is in the non-running state. While the fuel cell vehicle is in the running state, only a part of the exhaust gas passes through the duct, and the rest of the exhaust gas moves rearward, without passing through the duct, due to the wind flow.

In the above-described aspect, the duct may have a cross-sectional area that is larger than the opening area of an outlet of the discharge port.

With this aspect, the duct has a cross-sectional area larger than the opening area of the outlet of the discharge port. This facilitates collecting of the exhaust gas.

In the above-described aspect, the fuel cell vehicle may further comprise an under cover that is disposed more on the rearward side than the discharge port and covers an under floor of the fuel cell vehicle, and the guiding section may comprise a groove provided on the under cover, the groove extending from the discharge port to a portion more on the rearward side than the rear wheel axle.

With this aspect, the exhaust gas passes through the groove provided on the under cover to be guided to flow toward the rearward side beyond the rear wheel axle, while the fuel cell vehicle is in the non-running state. While the fuel cell vehicle is in the running state, only a part of the exhaust gas passes through the groove, and the rest of the exhaust gas moves rearward, without passing through the groove, due to the wind flow.

The present disclosure can be implemented in various modes, and may be implemented as a mode of an exhaust gas discharging method for a fuel cell vehicle, as well as a mode of a fuel cell vehicle.

What is claimed is:

1. A fuel cell vehicle comprising:
a fuel cell module;
a discharge port through which exhaust gas including water produced in the fuel cell module is discharged, the discharge port being disposed on an under floor and between a front wheel axle and a rear wheel axle of the fuel cell vehicle; and
a guiding section capable of guiding the exhaust gas to flow toward a rearward side beyond the rear wheel axle while the fuel cell vehicle is in a non-running state.

2. The fuel cell vehicle in accordance with claim 1 further comprising:
a speed meter; and
a controller that controls the guiding section in accordance with speed of the fuel cell vehicle,
wherein
the guiding section includes an outlet of the discharge port, and
the controller reduces an opening area of the outlet when the fuel cell vehicle is in the non-running state to be smaller than the opening area when the fuel cell vehicle is in a running state.

3. The fuel cell vehicle in accordance with claim 2, wherein
the guiding section includes a nozzle having an outlet an opening area of which is controllable, the nozzle being provided to the discharge port, and
the controller reduces the opening area of the outlet when the fuel cell vehicle is in the non-running state to be smaller than the opening area of the outlet when the fuel cell vehicle is in the running state.

4. The fuel cell vehicle in accordance with claim 2, wherein
the guiding section comprises
a silencer provided between the fuel cell module and the discharge port,
an opening through which the exhaust gas is discharged from the fuel cell vehicle without passing through the discharge port, and
a lid with which the opening is opened and closed, wherein
the discharge port has an opening area enabling the exhaust gas to flow at a flow velocity equal to or higher than a predetermined flow velocity to be discharged even when the fuel cell vehicle is in the non-running state, and
the controller controls the lid to be closed when the fuel cell vehicle is in the non-running state, and to be opened when the fuel cell vehicle is in the running state.

5. The fuel cell vehicle in accordance with claim 2, wherein
the guiding section further comprises a fan, and
the controller drives the fan at least when the fuel cell vehicle is in the non-running state to guide the exhaust gas toward the rearward side of the fuel cell vehicle.

6. The fuel cell vehicle in accordance with claim 1 further comprising:
a speed meter; and
a controller that controls the guiding section in accordance with speed of the fuel cell vehicle,
wherein
the guiding section comprises a fan, and
the controller drives the fan at least when the fuel cell vehicle is in the non-running state to guide the exhaust gas toward the rearward side of the fuel cell vehicle.

7. The fuel cell vehicle in accordance with claim 5 further comprising:
a radiator that cools the fuel cell module; and
a radiator fan that cools the radiator with air,
wherein
the radiator fan is used as a fan for the guiding section.

8. The fuel cell vehicle in accordance with claim 7, wherein
the fuel cell module is inclined to have a vehicle forward side disposed higher than a vehicle rearward side, and
the radiator fan is disposed more on the forward side than the fuel cell module and is positioned, in a height direction, to be capable of sending air below the fuel cell module.

9. The fuel cell vehicle in accordance with claim 7 further comprising
an under cover disposed below the radiator fan and the fuel cell module in a vertical direction.

10. The fuel cell vehicle in accordance with claim 1, wherein
the guiding section comprises a duct disposed more on the rearward side than the discharge port,
the duct has an inlet covering the discharge port from an upward side in a vertical direction, and
the duct has an outlet disposed more on the rearward side than the rear wheel axle.

11. The fuel cell vehicle in accordance with claim 10, wherein
the duct has a cross-sectional area that is larger than the opening area of an outlet of the discharge port.

12. The fuel cell vehicle in accordance with claim 1 further comprising
an under cover that is disposed more on the rearward side than the discharge port and covers an under floor of the fuel cell vehicle, wherein
the guiding section comprises a groove provided on the under cover, the groove extending from the discharge port to a portion more on the rearward side than the rear wheel axle.

13. A control method for a fuel cell vehicle comprising a fuel cell module, the method comprising
performing control in such a manner that an opening area of a discharge port, through which exhaust gas including water produced in the fuel cell module is discharged, is reduced when the fuel cell vehicle is in a non-running state to be smaller than the opening area when the fuel cell vehicle is in a running state.

14. The control method in accordance with claim 13, wherein
the discharge port comprises a first discharge port and a second discharge port that is an opening,
the opening is opened and closed with a lid, and
the performing control in such a manner that the opening area of the discharge port, through which the exhaust gas including water produced in the fuel cell module is discharged, is reduced comprises controlling the lid to be closed when the fuel cell vehicle is in the non-running state and to be opened when the fuel cell vehicle is in the running state.

15. A control method for a fuel cell vehicle comprising a fuel cell module, the method comprising:
controlling a fan to be driven, when the fuel cell vehicle is in a non-running state, to guide exhaust gas, including water generated in the fuel cell module, discharged from a discharge port to a rearward side of the fuel cell vehicle.

16. The control method in accordance with claim 15, wherein
the fan comprises a radiator fan that cools a radiator with air, the radiator cooling the fuel cell module.
